(19) United States
(12) Patent Application Publication
(10) Pub. No.: US 2024/0218234 A1
(43) Pub. Date: Jul. 4, 2024

(54) PARAFFIN WAX DISPERSANT

(71) Applicant: ChampionX LLC, Sugar Land, TX (US)

(72) Inventors: Shu Jun Yuan, Calgary (CA); Scott Kenneth Iverson, Slave Lake (CA); Duy T. Nguyen, Richmond, TX (US)

(21) Appl. No.: 18/543,198

(22) Filed: Dec. 18, 2023

Related U.S. Application Data
(60) Provisional application No. 63/476,880, filed on Dec. 22, 2022.

(51) Int. Cl. C09K 8/524

(52) U.S. Cl. CPC C09K 8/524

(57) ABSTRACT

A method includes introducing a paraffin wax dispersant composition to a hydrocarbon fluid. Another method includes storing or transporting a hydrocarbon fluid in or through a vessel, wherein the hydrocarbon fluid contains the paraffin wax dispersant composition. The paraffin wax dispersant composition can include a sorbitol-based compound, a quaternary ammonium compound, monoethanolamine, and alkyl benzene sulfonic acid in excess relative to the monoethanolamine. Alternatively, the paraffin wax dispersant composition can include a sorbitol-based compound, a quaternary ammonium compound, monoethanolamine, alkyl benzene sulfonic acid, and 2-mercaptoethanol, where monoethanolamine is in excess relative to the alkyl benzene sulfonic acid. A mixture can include the hydrocarbon fluid and the paraffin wax dispersant composition.

### CROSS-REFERENCE TO RELATED APPLICATIONS

This application claims the benefit of and priority to U.S. Provisional Patent Application No. 63/476,880, filed on Dec. 22, 2022, and entitled “Paraffin Wax Dispersant,” which is incorporated by reference in its entirety.

### FIELD OF THE DISCLOSURE

The present disclosure relates to dispersing paraffin wax particles in hydrocarbon fluids.

### BACKGROUND

Hydrocarbon fluids are generally produced from a subterranean formation to the surface, where the production fluids can be stored and/or transported. During the production, transport, and/or storage, the hydrocarbon fluids in some locations can be subjected to temperatures in such a range that the hydrocarbons may be present as solids within production lines.

These hydrocarbon fluids can include linear and branched paraffins having the general formula CₙH₂ₙ₊₂, where n may represent an integer in the range of 1 to 50. The higher n-number paraffins can have melting points that are greater than the temperatures present in some environments. For example, heptacosane (C₂₇H₅₆) has a melting point of 59.5° C., so when subjected to temperatures below 59.5° C., heptacosane would be in solid phase. Paraffins having more carbon atoms that heptacosane can have even higher melting points, e.g., melting points that are greater than 59.5° C. As such, these heavier paraffins, when present, would be present in solid phase at any temperature in the range of normal operation temperatures that could be between, for example, −40° C. and 60° C. These temperatures can be even more extreme in differing environments.

The paraffins that have melting points greater than the temperature in a particular location can form a wax that agglomerates and deposits on equipment in which the hydrocarbon fluid is transported and/or stored, such as pipes, pumps, compressors, values, storage vessels, and transportation vessels (rail cars, ocean tankers, etc.). The paraffin wax deposits reduce the effective volume of the structure in which they are deposited and can reduce the efficiency of producing, transporting, and storing hydrocarbon fluids and can lead to increased costs related to removing the paraffin wax deposits from the equipment.

Production of hydrocarbon fluids above the wax appearance temperature (WAT) can avoid the formation, agglomeration, and deposition of paraffin wax. In situations where hydrocarbon fluids are subject to temperatures below the WAT, paraffin inhibitors can be introduced downhole to prevent the formation of paraffin wax as the hydrocarbon fluid is transported to the surface and downstream of the wellhead. In some cases, downhole treatment with a paraffin inhibitor is not possible, while in other cases, downhole introduction of paraffin inhibitor alone does not address paraffin wax issues at the surface. Paraffin wax dispersants can be added to the hydrocarbon fluid at the surface. Increasing activity of the dispersants while remaining effective and stable under winterizing conditions is an ongoing challenge.

### SUMMARY

Disclosed herein are paraffin wax dispersant compositions, hydrocarbon fluids containing one or more of the paraffin wax dispersant compositions, and methods.

A paraffin wax dispersant composition comprises or consists of a sorbitol-based compound, a quaternary ammonium compound, monoethanolamine, and alkyl benzene sulfonic acid in excess relative to the monoethanolamine.

Another paraffin wax dispersant composition comprises or consists of a sorbitol-based compound, a quaternary ammonium compound, monoethanolamine, alkyl benzene sulfonic acid, and 2-mercaptoethanol, where monoethanolamine is in excess relative to the alkyl benzene sulfonic acid.

A hydrocarbon fluid can contain one or more of the paraffin wax dispersant compositions disclosed herein, referred to as a mixture comprising the hydrocarbon fluid and one or more of the paraffin wax dispersant compositions.

A method can include introducing a paraffin wax dispersant composition to a hydrocarbon fluid.

Another method that includes storing a transporting a hydrocarbon fluid comprising a paraffin wax dispersant composition disclosed herein.

Other technical features may be readily apparent to one skilled in the art from the following figures, descriptions, and claims.

### DETAILED DESCRIPTION

As used herein, any recited ranges of values contemplate all values within the range including the end points of the range, and are to be construed as support for claims reciting any sub-ranges having endpoints which are real number values within the recited range. By way of example, a disclosure in this specification of a range of from 10 to 15 shall be considered to support claims to values of 10, 11, 12, 13, 14, and 15, and to any of the following ranges: 10-11, 10-12, 10-13, 10-14, 10-15, 11-12, 11-13, 11-14, 11-15, 12-13; 12-14, 12-15, 13-14, 13-15, and 14-15. Similarly, by way of another example, a disclosure in this specification of a range of from 1.0 to 1.5 shall be considered to support claims to values of 1.0, 1.1, 1.2, 1.3, 1.4, and 1.5, and to any of the following ranges: 1.0-1.1, 1.0-1.2, 1.0-1.3, 1.0-1.4, 1.0-1.5, 1.1-1.2, 1.1-1.3, 1.1-1.4, 1.1-1.5, 1.2-1.3; 1.2-1.4, 1.2-1.5, 1.3-1.4, 1.3-1.5, and 1.4-1.5.

Disclosed are paraffin wax dispersant compositions for use in hydrocarbon fluids that are produced, transported, or stored in equipment. One such embodiment is a group of paraffin wax dispersant compositions that are suitable for use in environments having temperatures as low as −35° C., and another such embodiment is a group of paraffin wax dispersant compositions that are suitable for use in environments having temperatures as low as −40° C.

All of the paraffin wax dispersant compositions disclosed herein include monoethanolamine (MEA) and an alkyl benzene sulfonic acid (ABSA) added to a base surfactant package of a sorbitol-based compound and a quaternary ammonium compound. MEA and ABSA react to produce a neutralized salt complex that decreases the overall viscosity of the paraffin wax dispersant composition, allowing the composition to remain mobile in hydrocarbon fluids at freezing conditions. It was observed that the paraffin wax dispersant compositions without 2-mercaptoethanol remain stable at temperatures down to −35° C. It was also observed that paraffin wax dispersant compositions having 2-mercaptoethanol remain stable at temperatures down to −40° C. Since 2-mercaptoethanol was added as a synergist compound for increasing corrosion inhibition with the present quaternary ammonium compound, it was unexpected that 2-mercaptoethanol would also improve stability of the paraffin wax dispersant composition at temperatures down to −40° C.

The first group of compositions includes paraffin wax dispersant compositions having a sorbitol-based compound, a quaternary ammonium compound, a solvent, monoethanolamine, and an alkyl benzene sulfonic acid, where the alkyl benzene sulfonic acid is present in excess relative to monoethanolamine. The first group of compositions does not contain the synergizing agent disclosed herein, 2-mercaptoethanol. In optional aspects, the first group of compositions can include a solubility agent, such as xylene. In aspects, the concentration ranges of components in the first group of compositions includes 3 wt % to 6 wt % sorbitol-based compound, 20 wt % to 40 wt % quaternary ammonium compound, 0.1 wt % to 1 wt % MEA, 1 wt % to 3 wt % ABSA, and 50 wt % to 80 wt % solvent, based on a total weight of the paraffin wax dispersant composition. A solubility agent can be included in a range of from 2 wt % to 4 wt % based on a total weight of the paraffin wax dispersant composition. In further aspects, the total activity of the paraffin wax dispersant compositions in the first group can be in a range of from 20 wt % to 50 wt % based on a total weight of the paraffin wax dispersant composition.

The second group of compositions includes paraffin wax dispersant compositions having a sorbitol-based compound, a quaternary ammonium compound, a solvent, monoethanolamine, an alkyl benzene sulfonic acid, and a synergizing agent, where the monoethanolamine is present in excess relative to the alkyl benzene sulfonic acid. In aspects, the synergizing agent is 2-mercaptoethanol. In optional aspects, the second group of compositions can include a solubility agent, such as xylene. The concentration ranges of components in the second group of compositions includes: 2 wt % to 4 wt % sorbitol-based compound, 12 wt % to 31 wt % quaternary ammonium compound, 1.3 wt % to 2.9 wt % MEA, 0.2 wt % to 0.5 wt % ABSA, 2 wt % to 5 wt % 2-mercaptoethanol, and 56 wt % to 78 wt % solvent, based on a total weight of the paraffin wax dispersant composition. A solubility agent can be included in a range of from 2 wt % to 4 wt %, based on a total weight of the paraffin wax dispersant composition. In further aspects, the total activity of the paraffin wax dispersant compositions in the second group can be in a range of from 20 wt % to 50 wt %, based on a total weight of the paraffin wax dispersant composition.

### Sorbitol-Based Compound

The sorbitol-based compound can be any sorbitol-based compound that functions as a nonionic surfactant. In aspects, the sorbitol-based compound comprises an EO-PO-sorbitol. Sorbitol contains six hydroxyl groups. One or more of the six of the hydroxyl groups can be reacted with different compounds to form the sorbitol-based compound. In most cases, commercial sorbitol starter materials have the capability to initially react with PO. Further reactions with EO-PO at different ratios can determine the solubility of the final component. In this case, the EO-PO ratios favors the water phase. In additional aspects, the sorbitol-based compound is a glucitol-based compound. An example of a glucitol-based compound is an oxirane, methyl-, polymer with oxirane, monomethyl ether D-glucitol.

In aspects, the sorbitol-based compound can be present in the paraffin wax dispersant composition in a range of from about 1 wt % to about 5 wt %, based on a total weight of the paraffin wax dispersant composition. In aspects, the paraffin wax dispersant composition can contain about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt % of the sorbitol-based compound, based on a total weight of the paraffin was dispersant composition.

### Quaternary Ammonium Compound

The quaternary ammonium compound can be any quaternary ammonium compound that functions as a cationic surfactant. Quaternary ammonium compounds can include, but are not limited to, tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, trialkyl benzyl quaternary ammonium compounds, or combinations thereof. In compounds having one or more alkyl groups, the alkyl group can contain from about 6 to about 24 carbon atoms; alternatively, from about 10 to about 18 carbon atoms; alternatively, from about 12 to about 16 carbon atoms. Examples of quaternary ammonium compounds that are referred to as “quats” can include, but are not limited to, trialkyl-, dialkyl-, dialkoxy alkyl-, monoalkoxy-, benzyl-, and imidazolinium-quaternary ammonium compounds and salts thereof.

Examples of the quaternary ammonium compound that are salts include an alkylamine benzyl quaternary ammonium salt, a benzyl triethanolamine quaternary ammonium salt, a benzyl dimethylaminoethanolamine quaternary ammonium salt, or combinations thereof.

Additional examples of alkyl-, hydroxyalkyl-, alkylaryl-, arylalkyl-, and aryl-amine quaternary salts include those having the formula [N⁺R^{5a}R^{6a}R^{7a}R^{8a}][X³¹], wherein R^{5a}, R^{6a}, R^{7a}, and R^{8a} contain one to 18 carbon atoms, and X is Cl, Br, or I. In certain embodiments, R^{5a}, R^{6a}, R^{7a}, and R^{3a} are each independently selected from alkyl (e.g., C₁-C₁₈ alkyl), hydroxyalkyl (e.g., C₁-C₁₈ hydroxyalkyl), and arylalkyl (e.g., benzylakyl). The mono or polycyclic aromatic amine salt with an alkyl or alkylaryl halide include salts of the formula [N+R^{5a}R^{6a}R^{7a}R^{8a}][X³¹] wherein R^{8a}, R^{6a}, R^{7a}, and R^{8a} contain one to 18 carbon atoms, and X is Cl, Br, or I.

In aspects, the quaternary ammonium compound can be represented by the formula:

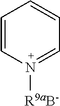

wherein R^{9a} is an alkyl group, an aryl group, or an arylalkyl group, wherein the alkyl groups have from 1 to about 18 carbon atoms and B is Cl, Br, or I. Among these compounds are alkyl pyridinium salts and alkyl pyridinium benzyl quats. Examples include methylpyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium and an alkyl benzyl pyridinium chloride, preferably wherein the alkyl group is a C₁-C₆ hydrocarbyl group. In certain embodiments, the quaternary ammonium compound includes benzyl pyridinium chloride.

The quaternary ammonium compound can be present in the paraffin wax dispersant composition in a range of from about 10 wt % to about 35 wt %, based on a total weight of the paraffin wax dispersant composition. In aspects, the paraffin wax dispersant composition can contain about 10, 11, 12, 13, 14, 15, 16, 17, 18, 19, 20, 21, 22, 23, 24, 25, 26, 27, 28, 29, 30, 31, 32, 33, 34, or 35 wt % of the quaternary ammonium compound, based on a total weight of the paraffin was dispersant composition.

### Monoethanolamine

Monoethanolamine (MEA) can be present in the paraffin wax dispersant composition in a range of from about 0.5 wt % to about 3 wt %, based on a total weight of the paraffin wax dispersant composition. In aspects, the paraffin wax dispersant composition can contain about 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 wt % of monoethanolamine, based on a total weight of the paraffin was dispersant composition.

### Alkyl Benzene Sulfonic Acid

The alkyl group of the alkyl benzene sulfonic acid (ABSA) can have from 10 to 16 carbon atoms, and can be linear or branched. In some aspects, the alkyl benzene sulfonic acid can include a mixture of C₁₀-C₁₆ alkyl benzene sulfonic acid compounds. In aspects, the alkyl benzene sulfonic acid can be present in the paraffin wax dispersant composition in a range of from about 0.2 wt % to about 3 wt %, based on a total weight of the paraffin wax dispersant composition. In aspects, the paraffin wax dispersant composition can contain about 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 wt % of the ABSA, based on a total weight of the paraffin was dispersant composition.

### Ratio of MEA to ABSA

In aspects, the paraffin wax dispersant compositions can have MEA and ABSA present in a mass ratio of less than 1:1. This mass ratio range can be referred to as ABSA in excess of MEA. In aspects, the mass ratio of MEA to ABSA can be in a range of from 0.1:1 to less than 1:1. For example, the mass ratio of MEA to ABSA can be about 0.1:1, 0.2:1, 0.3:1, 0.4:1, 0.5:1, 0.6:1, 0.7:1, 0.8:1, or 0.9:1. In alternative aspects, the paraffin wax dispersant compositions can have MEA and ABSA present in a mass ratio of 1:1 or greater. This mass ratio range can be referred to as MEA in excess of ABSA. In aspects, the mass ratio of MEA to ABSA can be in a range of from 1:1 to 10:1. For example, the mass ratio of MEA to ABSA can be about 1:1, 1.5:1, 2:1, 2.5:1, 3:1, 3/5:1. 4:1, 4.5:1, 5:1, 5.5:1, 6:1, 6.5:1, 7:1, 7.5:1, 8:1, 8.5:1, 9:1, 9.5:1, or 10:1.

### Synergizing Agent

In some aspects, the paraffin wax composition can include a synergizing agent. The synergizing agent disclosed herein can be 2-mercaptoethanol. The synergizing agent can be present in the paraffin wax dispersant composition in a range of from greater than 0.0 wt % to about 10 wt %; alternatively, greater than 0.0 wt % to about 5 wt %; alternatively, from about 1 wt % to about 5 wt %; alternatively, from about 2 wt % to 5 wt %; alternatively, from about 1 wt % to about 4 wt %; alternatively, from about 1 wt % to about 3 wt %; alternatively, about 2 wt %, based on a total weight of the paraffin wax dispersant composition. In aspects, the paraffin wax dispersant composition can contain about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 wt % of the synergizing agent, based on a total weight of the paraffin was dispersant composition.

In some aspects, the paraffin wax dispersant composition contains no synergizing agent, e.g., there is no detectable amount of 2-mercaptoethanol in the paraffin wax dispersant composition when a sample of the paraffin wax dispersant is measured with a gas chromatograph or other chemical composition measurement equipment.

### Solvent

The paraffin wax dispersant composition can further include one or more solvents. Examples of solvents include, but are not limited to, water, alcohols, hydrocarbons, ketones, ethers, aromatics, amides, nitriles, sulfoxides, esters, glycol ethers, aqueous systems, and combinations thereof. In aspects, the solvent is water, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or combinations thereof. Representative polar solvents suitable for formulation with the composition include water, brine, seawater, alcohols (including straight chain or branched aliphatic such as methanol, ethanol, propanol, isopropanol, butanol, 2-ethylhexanol, hexanol, octanol, decanol, 2-butoxyethanol, etc.), glycols and derivatives (ethylene glycol, 1,2-propylene glycol, 1,3-propylene glycol, ethylene glycol monobutyl ether, etc.), ketones (cyclohexanone, diisobutylketone), N-methylpyrrolidinone (NMP), N,N-dimethylformamide, or combinations thereof. Representative non-polar solvents suitable for formulation with the composition include aliphatic hydrocarbons such as pentane, hexane, cyclohexane, methylcyclohexane, heptane, decane, dodecane, diesel, or combinations thereof; aromatic hydrocarbons such as toluene, xylene, heavy aromatic naphtha, fatty acid derivatives (acids, esters, amides), or combinations thereof; or any combination of aliphatic hydrocarbons and aromatic hydrocarbons.

In aspects, the solvent is a polyhydroxylated solvent, a polyether, an alcohol, or a combination thereof. In aspects, the solvent is monoethyleneglycol, methanol, dimethyl sulfoxide (DMSO), dimethylformamide (DMF), tetrahydrofuran (THF), or a combination thereof.

A paraffin wax dispersant composition may comprise from 0 wt % to 99 wt %; alternatively, from 1 wt % to 98 wt % of one or more solvents; alternatively, from about 50 wt % to about 80 wt %; alternatively, from about 55 wt % to about 80 wt %; alternatively, from about 56 wt % to about 78 wt %, based on total weight of the paraffin wax dispersant composition. In aspects, a paraffin wax dispersant composition disclosed herein can include 50, 55, 60, 65, 70, 75, or 80 wt % of one or more solvents, based on total weight of the paraffin wax dispersant composition.

In some aspects, the solvent can include a first component and a second component. By nonlimiting example, the first component can include water, and the second component can include methanol. In aspects, the mass ratio of the first component to the second component can be 1:1 or less. For example, the mass ratio of the mass ratio of the first component to the second component can be about 0.1:1, 0.2:1, 0.3:1, 0.4:1, 0.5:1, 0.6:1, 0.7:1, 0.8:1, 0.9:1, or 1:1.

### Solubility Agent

The solubility agent can be any hydrocarbon that improves solubility of the active compounds present in the disclosed compositions. An example of the solubility agent is xylene. The solubility agent can be present in the paraffin wax dispersant composition in a range of from about 1 wt % to about 5 wt %; alternatively, from about 2 wt % to about 4 wt %, based on a total weight of the paraffin wax dispersant composition.

### Total Activity

Total activity for the paraffin wax dispersant compositions disclosed herein is defined as the sum wt % of 1) sorbitol-based compound, 2) quaternary ammonium compound, 3) monoethanolamine, 4) alkyl benzene sulfonic acid, and 5) 2-mercaptoethanol (when present), based on a total weight of the paraffin wax dispersant composition. In aspects, the total activity can be in a range of from about 20 wt % to about 50 wt %; alternatively, from about 20 wt % to about 40 wt %; alternatively, from about 30 wt % to about 40 wt %; alternatively, about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %, based on a total weight of the paraffin wax dispersant composition.

### Additional Components

Additional components for combination with the paraffin wax dispersant compositions include phosphate ester, monomeric or oligomeric fatty acids, asphaltene inhibitors, paraffin inhibitors, scale inhibitors, emulsifiers, water clarifiers, emulsion breakers, hydrogen sulfide scavengers, gas hydrate inhibitors, biocides, pH modifiers, functional agents and other additives, or combinations thereof.

### Phosphate Esters

In aspects, the phosphate esters can include, but are not limited to, mono-, di- or tri-alkyl or alkylaryl phosphate esters; phosphate esters of hydroxylamines; phosphate esters of polyols, or combinations thereof.

Suitable mono-, di- and tri-alkyl phosphate esters, mono-, di- and tri-alkylaryl phosphate esters, and phosphate esters of mono-, di-, and tri-ethanolamine typically contain from 1 to about 18 carbon atoms. In some aspects, the mono-, di- and trialkyl phosphate esters, mono-, di- and tri-alkylaryl phosphate esters, and mono-, di- and tri-arylalkyl phosphate esters are those prepared by reacting a C₃-C₁₈ aliphatic alcohol with phosphorous pentoxide. The phosphate intermediate interchanges its ester groups with triethyl phosphate with triethylphosphate producing a broader distribution of alkyl phosphate esters. Alternatively, the phosphate ester may be made by admixing with an alkyl diester, a mixture of low molecular weight alkyl alcohols or diols. The low molecular weight alkyl alcohols or diols preferably include C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are preferred.

### Monomeric and Oligomeric Fatty Acid

The monomeric or oligomeric fatty acid can include, but are not limited to, C₁₄-C₂₂ saturated and unsaturated fatty acids as well as dimer, trimer and oligomer products obtained by polymerizing one or more of such fatty acids.

### Asphaltene Inhibitors

Asphaltene inhibitors can include, but are not limited to, aliphatic sulphonic acids; alkyl aryl sulphonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids; salts of alkyl succinates; sorbitan monooleate; and polyisobutylene succinic anhydride, or combinations thereof.

### Paraffin Inhibitors

Paraffin inhibitors can include, but are not limited to, paraffin crystal modifiers, pour point depressants, and pour point depressants/dispersant/crystal modifier combinations. Examples of paraffin crystal modifiers/pour point depressants include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax, asphaltenes, or combinations thereof. Examples of dispersants include, but are not limited to, dodecyl benzene sulfonate, oxyalkylated alkylphenols, and oxyalkylated alkylpnenolic resins, or combinations thereof.

### Scale Inhibitors

Scale inhibitors can include, but are not limited to, phosphates, phosphate esters, phosphoric acids, phosphonates, phosphonic acids, polyacrylamides, salts of acrylamido-methyl propane sulfonate/acrylic acid copolymer (AMPS/AA), phosphinated maleic copolymer (PHOS/MA), salts of a polymaleic acid/acrylic acid/acrylamido-methyl propane sulfonate terpolymer (PMA/AMPS), or combinations thereof.

### Emulsifiers

Emulsifiers can include, but are not limited to, salts of carboxylic acids, products of acylation reactions between carboxylic acids or carboxylic anhydrides and amines, alkyl-, acyl-, and amide derivatives of saccharides (alkyl-saccharide emulsifiers), or combinations thereof.

### Water Clarifiers

Water clarifiers can include, but are not limited to, inorganic metal salts such as alum, aluminum chloride, and aluminum chlorohydrate; organic polymers such as acrylic acid based polymers; acrylamide based polymers; polymerized amines; alkanolamines; thiocarbamates; cationic polymers such as diallyldimethylammonium chloride (DADA); or combinations thereof.

### Emulsion Breakers

Emulsion breakers can include, but are not limited to, dodecyl benzene sulfonic acid, the sodium salt of xylenesulfonic acid (NAXSA), epoxylated and propoxylated compounds, anionic cationic and nonionic surfactants, resins such as phenolic resins and epoxide resins, or combinations thereof.

### Hydrogen Sulfide Scavengers

Hydrogen sulfide scavengers can include, but are not limited to, oxidants (e.g., inorganic peroxides such as sodium peroxide, or chlorine dioxide), aldehydes (e.g., of 1 to 10 carbon atoms such as formaldehyde or glutaraldehyde or (meth)acrolein), triazines (e.g., monoethanol amine triazine, monomethylamine triazine, and triazines from multiple amines or mixtures thereof), glyoxal, or combinations thereof.

### Gas Hydrate Inhibitors

Gas hydrate inhibitors can include, but are not limited to, thermodynamic hydrate inhibitors (THI), kinetic hydrate inhibitors (KHI), anti-agglomerates (AA), or combinations thereof.

Examples of thermodynamic hydrate inhibitors include, but are not limited to, NaCl salt, KCl salt, CaCl₂ salt, MgCl₂ salt, NaBr₂ salt, formate brines (e.g. potassium formate), polyols (e.g., glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, triglycerol, sugar alcohols (e.g. sorbitol, mannitol), or combinations thereof), methanol, propanol, ethanol, glycol ethers (e.g., diethyleneglycol monomethylether, ethyleneglycol monobutylether, or combinations thereof), alkyl or cyclic esters of alcohols (e.g., ethyl lactate, butyl lactate, methylethyl benzoate, or combinations thereof), or combinations thereof.

Examples of kinetic hydrate inhibitors and anti-agglomerates include, but are not limited to, polymers and copolymers, polysaccharides (e.g., hydroxy-ethylcellulose (HEC), carboxymethylcellulose (CMC), starch, starch derivatives, xanthan, or combinations thereof), lactams (e.g., polyvinylcaprolactam, polyvinyl lactam), pyrrolidones (e.g., polyvinyl pyrrolidone of various molecular weights), surfactants (e.g., fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines, or combinations thereof), hydrocarbon based dispersants (e.g., lignosulfonates, iminodisuccinates, polyaspartates, or combinations thereof), amino acids, proteins, or combinations thereof.

### Biocides

Biocides can include, but are not limited to, oxidizing and non-oxidizing biocides. Examples of non-oxidizing biocides include, for example, aldehydes (e.g., formaldehyde, glutaraldehyde, acrolein, or combinations thereof), amine-type compounds (e.g., quaternary amine compounds, cocodiamine, or a combination thereof), halogenated compounds (e.g., bronopol, 2-2-dibromo-3-nitrilopropionamide (DBNPA), or a combination thereof), sulfur compounds (e.g., isothiazolone, carbamates, metronidazole, or a combination thereof), quaternary phosphonium salts (e.g., tetrakis(hydroxymethyl)phosphonium sulfate (THPS)), or combinations thereof.

Examples of oxidizing biocides include sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, peroxides, or combinations thereof.

### pH Modifiers

pH modifiers can include, but are not limited to, alkali hydroxides, alkali carbonates, alkali bicarbonates, alkaline earth metal hydroxides, alkaline earth metal carbonates, alkaline earth metal bicarbonates, or combinations thereof. Exemplary pH modifiers include NaOH, KOH, Ca(OH)₂, CaO, Na₂CO₃, KHCO₃, K₂CO₃, NaHCO₃, MgO, and Mg(OH)₂, or combinations thereof.

### Functional Agents and Other Additives

The paraffin wax dispersant compositions may further include additional functional agents or additives that provide a beneficial property. Additional agents or additives will vary according to the particular composition being manufactured and its intended use as one skilled in the art will appreciate. According to one embodiment, the compositions do not contain any of the additional agents or additives.

### Concentration of Additional Components

When additional components described herein are combined with a paraffin wax dispersant composition described herein, the concentrations described the additional component(s) can be present in the total composition in a range of from 0 wt % to 80 wt %, 0 wt % to 60 wt %, or 0 wt % to 50 wt %, based on total weight of the total composition.

### Hydrocarbon Fluid and Concentration of the Paraffin Wax Dispersant Composition

In aspects, the hydrocarbon fluid that contains a disclosed paraffin wax dispersant composition can include crude oil, hydrocarbon gas, condensate, or combinations thereof. The hydrocarbon fluid can be produced, stored, or transported in or through a vessel comprising hydrocarbon production equipment, a storage tank, rail car, tank truck, marine vessel, barge, pipeline, or combinations thereof. Hydrocarbon production equipment can include a pipe, valve, or pump, for example.

The concentration of the paraffin wax dispersant composition in the hydrocarbon fluid can be in a range of from about 100 ppmw to about 1,000 ppmw; alternatively, from about 350 ppmw to about 1,000 ppmw; alternatively, from about 400 ppmw to about 800 ppmw; alternatively, from about 500 ppmw to about 800 ppmw; alternatively, from about 600 ppmw to about 800 ppmw. For example, the concentration of the paraffin wax dispersant composition in the hydrocarbon fluid can be about 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, or 800 ppmw, based on a total weight of the hydrocarbon fluid.

### Methods

A method disclosed herein includes introducing a paraffin wax dispersant composition to a hydrocarbon fluid. The hydrocarbon fluid can be moving or stationary in an equipment, such as any storage or transportation vessel including but not limited to a storage tank, rail car, tank truck, marine vessel, barge, pipeline, or combinations thereof.

The paraffin wax dispersant composition can be introduced to the hydrocarbon fluid by injecting, adding, or introducing the paraffin wax dispersant composition into one of the above-mentioned vessels, where the hydrocarbon fluid is contained in or transported through the vessel. In aspects, the paraffin wax dispersant composition can be injected, added, or introduced via an injection valve and/or pump that is fluidly connected to the vessel.

Another method disclosed herein includes storing or transporting a hydrocarbon fluid in or through a vessel of the type disclosed herein, wherein the hydrocarbon fluid contains a paraffin wax dispersant composition that is disclosed herein.

### Examples

The following examples are intended to illustrate various aspects and embodiments of the disclosed paraffin wax dispersant compositions and are not to be considered limiting. It will be recognized that various modifications and changes may be made to the experimental compositions described herein, and without departing from the scope of the claims.

### Paraffin Wax Dispersant Compositions

Seven paraffin wax dispersant compositions were tested for compatibility, performance, and stability. The compositions were also subject to winterization conditions (−35° C. and −40° C.) and evaluated.

The compositions are shown in Table 1 below. All values reported are in wt %, based on a total weight of the composition.

TABLE 1

| | Paraffin Wax Dispersant Compositions | | | | | | |
|---|---|---|---|---|---|---|---|
| | 1 | 2 | 3 | 4 | 5 | 6 | 7 |
| Oxirane, Methyl-, | 4.768 | 2 | 1.5 | 4 | 4 | 4 | 3.5 |
| Polymer with | | | | | | | |
| Oxirane, Ether with | | | | | | | |
| D-Glucitol (6:1) | | | | | | | |
| Mixture of C₁₂-C₁₆ | 31.816 | 14.2 | 12 | 18.7 | 23.7 | 30.6 | 28.6 |
| Alkyl Dimethyl | | | | | | | |
| Benzyl Ammonium | | | | | | | |
| Chlorides | | | | | | | |
| Monoethanolamine | 0.536 | 1.5 | 1.3 | 2 | 2 | 2.9 | 2.5 |
| Dodecyl Benzene | 2.88 | 0.3 | 0.2 | 0.3 | 0.3 | 0.5 | 0.4 |
| Sulfonic Acid - Soft | | | | | | | |
| 2-Mercaptoethanol | — | 2 | 5 | 2 | 2 | 2 | 5 |
| Water | 28 | 33 | 33 | 28 | 25.5 | 20 | 21 |
| Methanol | 28 | 45 | 45 | 42 | 39.5 | 36 | 36 |
| Xylene | 4 | 2 | 2 | 3 | 3 | 4 | 3 |
| Total | 100 | 100 | 100 | 100 | 100 | 100 | 100 |

For the sorbitol-based compound (i.e., oxirane, methyl-, polymer with oxirane, ether with D-Glucitol), the ratio of 6:1 means that 6 hydroxyl groups of the sorbitol (i.e., D-Glucitol) are reacted. The CAS # for the oxirane, methyl-, polymer with oxirane, ether with D-Glucitol is 56449-05-9.

Total activity of the compositions is reported below. Total activity is defined as the sum wt % of 1) oxirane, methyl-, polymer with oxirane, ether with D-glucitol, 2) mixture of C₁₂ to C₁₆ alkyl dimethyl benzyl ammonium chloride, 3) monoethanolamine, 4) dodecyl benzene sulfonic acid—soft, and 5) 2-mercaptoethanol. For Paraffin Wax Dispersant Composition 1, no 2-mercaptoethanol was added, so the contribution of 2-mercaptoethanol to the total activity was zero.

Paraffin Wax Dispersant Composition 1. Total activity of 40 wt % with no 2-mercaptoethanol. Dodecyl benzene sulfonic acid (DDBSA) was present in excess relative to monoethanolamine (MEA). Particularly, the mass ratio of MEA to DDBSA was 0.186:1. Water and methanol were the first component and the second component of the solvent, respectively; and the mass ratio of water to methanol was 1:1.

Paraffin Wax Dispersant Composition 2. Total activity of 20 wt % with 2 wt % 2-mercaptoethanol. MEA was present in excess relative to DDBSA. Particularly, the mass ratio of MEA to DDBSA was 5:1. Water and methanol were the first component and the second component of the solvent, respectively; and the mass ratio of water to methanol was 0.73:1.

Paraffin Wax Dispersant Composition 3. Total activity of 20 wt % with 5 wt % 2-mercaptoethanol. MEA was present in excess relative to DDBSA. Particularly, the mass ratio of MEA to DDBSA was 6.5:1. Water and methanol were the first component and the second component of the solvent, respectively; and the mass ratio of water to methanol was 0.73:1.

Paraffin Wax Dispersant Composition 4. Total activity of 27 wt % with 2 wt % 2-mercaptoethanol. MEA was present in excess relative to DDBSA. Particularly, the mass ratio of MEA to DDBSA was 6.7:1. Water and methanol were the first component and the second component of the solvent, respectively; and the mass ratio of water to methanol was 0.67:1.

Paraffin Wax Dispersant Composition 5. Total activity of 32 wt % with 2 wt % 2-mercaptoethanol. MEA was present in excess relative to DDBSA. Particularly, the mass ratio of MEA to DDBSA was 6.7:1. Water and methanol were the first component and the second component of the solvent, respectively; and the mass ratio of water to methanol was 0.65:1.

Paraffin Wax Dispersant Composition 6. Total activity of 40 wt % with 2 wt % 2-mercaptoethanol. MEA was present in excess relative to DDBSA. Particularly, the mass ratio of MEA to DDBSA was 5.8:1. Water and methanol were the first component and the second component of the solvent, respectively; and the mass ratio of water to methanol was 0.56:1.

Paraffin Wax Dispersant Composition 7. Total activity of 40 wt % with 5 wt % of 2-mercaptoethanol. MEA was present in excess relative to DDBSA. Particularly, the mass ratio of MEA to DDBSA was 6.25:1. Water and methanol were the first component and the second component of the solvent, respectively; and the mass ratio of water to methanol was 0.58:1.

Paraffin Wax Dispersant Composition 1 has DDBSA in excess of MEA without any 2-mercaptoethanol added and total activity of 40 wt %, with components at the following concentrations: 1) 4.678 wt % oxirane, methyl-, polymer with oxirane, ether with D-glucitol, 2) 31.816 wt % of the mixture of C₁₂ to C₁₆ alkyl dimethyl benzyl ammonium chloride, 3) 0.536 wt % MEA, 4) 2.88 wt % DDBSA, 5) 56 wt % solvent, and 6) 4 wt % xylene.

Paraffin Wax Dispersant Compositions 2 to 7 have MEA in excess of DDBSA with addition of 2-mercaptoethanol and total activity of 20 wt % to 40 wt %. The concentration ranges of components in Paraffin Wax Dispersant Compositions 2 to 7 is 1) 2 wt % to 4 wt % oxirane, methyl-, polymer with oxirane, ether with D-glucitol, 2) 12 wt % to 31 wt % of the mixture of C₁₂ to C₁₆ alkyl dimethyl benzyl ammonium chloride, 3) 1.3 wt % to 2.9 wt % MEA, 4) 0.2 wt % to 0.5 wt % DDBSA, 5) 2 wt % to 5 wt % 2-mercaptoethanol, 6) 56 wt % to 78 wt % solvent, and 7) 2 wt % to 4 wt % xylene.

### Paraffin Wax Dispersant Composition Evaluation

Evaluation was conducted under a paraffin dispersant bottle test. The paraffin dispersant bottle test involved preparation of samples for evaluation, and cooling of the samples to evaluate wax dispersion.

Preparation of samples for evaluation: The following procedure was performed to prepare each sample for evaluation: 1) 90 mL of chemical-free produced water was added to a 170 mL bottle; 2) 10 mL of hydrocarbon condensates were added to the 180 mL bottle containing the 90 mL of chemical-free produced water; 3) the paraffin wax dispersant composition was added in the concentration indicated below, where the concentration is based on the total weight of the fluids in the bottle; 4) wax was added to the bottle in the amount indicated below; 5) each bottle was capped and then shaken 10 times; 6) the bottle was added to a warm water bath for 1 hour or until the wax melted and the cap was loosened slightly to allow pressurized gas to escape from the bottle. The temperature of the warm water bath was slightly above the wax melting temperature, in a range of 70° C. to 80° C.

Cooling the samples to evaluate wax dispersion: The following procedure was performed to evaluate wax dispersion in each sample: 1) the bottle cap was tightened to prevent spill of any liquid, and the bottle was removed from the water bath; 2) the bottle was shaken 10 times, and the bottle cap was again loosed slightly to allow pressured gas to escape from the bottle; 3) the bottle cap was again tightened; 4) the bottle was continuously shaken while periodically placing the bottle in cooling water until the bottle reached the temperature of the cooling water; 5) the bottle was then evaluated for a) emulsion breaking speed, b) water clarity, c) interface sharpness, d) wax structure, e) amount of wax deposition to the surface of the bottle.

Evaluation results were reported as: G=Good, F=Fair, P=Poor, and B=Bad. Additional levels of evaluation include 1) +, which is enhancement over good, 2) ++, which is excellent performance above the grade, 3) −, which is performance slightly less than grade but still better than the lower grade.

The same chemical-free produced water composition was used for each example. The same hydrocarbon condensate composition was used for each example.

Evaluation results are in the table below:

TABLE 2

| | | | Amount of | Amount of 2- | |
|---|---|---|---|---|---|
| | | | Paraffin Amount | ME in the | |
| | | | of Wax Dispersant | Paraffins Wax | |
| | Paraffin Wax | Amount of | Composition | Dispersant | |
| | Dispersant | Wax Added | Added to Bottle | Composition | |
| Sample | Composition | to Bottom | (ppmw of bottle | (wt % of | |
| (#) | (#) | (g) | contents) | composition) | Grade |
| 1 | 1 | 7 | 450 | — | G++ |
| 2 | 1 | 7 | 500 | — | G+ |
| 3 | 1 | 7 | 400 | — | B |
| 4 | 1 | 7 | 500 | — | B |
| 5 | 1 | 7 | 600 | — | G |
| 6 | 1 | 5 | 300 | — | F |
| 7 | 1 | 5 | 400 | — | G |
| 8 | 1 | 5 | 500 | — | G+ |
| 9 | 1 | 5 | 325 | — | F+ |
| 10 | 1 | 5 | 350 | — | G |
| 11 | 1 | 5 | 375 | — | G+ |
| 12 | 2 | 5 | 300 | 2 | B |
| 13 | 2 | 5 | 400 | 2 | B |
| 14 | 2 | 5 | 500 | 2 | P |
| 15 | 2 | 5 | 600 | 2 | P |
| 16 | 2 | 5 | 800 | 2 | G+ |
| 17 | 3 | 5 | 300 | 5 | B |
| 18 | 3 | 5 | 400 | 5 | B |
| 19 | 3 | 5 | 500 | 5 | P− |
| 20 | 3 | 5 | 600 | 5 | P+ |
| 21 | 3 | 5 | 800 | 5 | P+ |
| 22 | 4 | 5 | 300 | 2 | P+ |
| 23 | 4 | 5 | 400 | 2 | F− |
| 24 | 4 | 5 | 500 | 2 | G− |
| 25 | 5 | 5 | 500 | 2 | G+ |
| 26 | 6 | 5 | 300 | 2 | F+ |
| 27 | 6 | 5 | 400 | 2 | G |
| 28 | 6 | 5 | 500 | 2 | G+ |
| 29 | 6 | 5 | 325 | 2 | P+ |
| 30 | 6 | 5 | 350 | 2 | G− |
| 31 | 6 | 5 | 375 | 2 | G− |
| 32 | 7 | 5 | 300 | 5 | F |
| 33 | 7 | 5 | 400 | 5 | G |
| 34 | 7 | 5 | 500 | 5 | G+ |
| 35 | 7 | 5 | 325 | 5 | F+ |
| 36 | 7 | 5 | 350 | 5 | G−− |
| 37 | 7 | 5 | 375 | 5 | G−− |

Samples 1 to 11 overall indicate that Paraffin Wax Dispersant Composition 1 having total activity of 40 wt % with no 2-mercaptoethanol and with DDBSA present in excess relative to MEA can function at certain doses/concentrations as a paraffin wax dispersant. It is noted that performance was not good at composition concentrations below 350 ppmw, e.g., at 325 ppmw and 300 ppmw.

Samples 12 to 16 indicate that Paraffin Wax Dispersant Composition 2 having total activity of 20 wt % with 2 wt % 2-mercaptoethanol and with MEA present in excess relative to DDBSA can function as paraffin wax inhibitors at higher dose levels, e.g., at 800 ppmw.

Samples 17 to 21 indicate that Paraffin Wax Dispersant Composition 3 having total activity of 20 wt % with 5 wt % 2-mercaptoethanol and with MEA present in excess relative to DDBSA, does not perform well as a paraffin wax dispersant. The 5 wt % 2-mercaptoethanol appears to be an upper boundary for presence of 2-mercaptoethanol, regarding performance of the composition as a paraffin wax dispersant, when the total activity is 20 wt %.

Samples 22 to 31 demonstrate the effect of increasing total activity on dispersant performance of Paraffin Wax Dispersant Compositions 4, 5, and 6, with each composition having MEA present in excess relative to DDBSA and with 2-mercaptoethanol present. Recall that Paraffin Wax Dispersant Composition 4 had a total activity of 27 wt % with 2 wt % 2-mercaptoethanol, Paraffin Wax Dispersant Composition 5 had a total activity of 32 wt % with 2 wt % 2-mercaptoethanol, Paraffin Wax Dispersant Composition 6 had a total activity of 40 wt % with 2 wt % 2-mercaptoethanol. It can be seen that performance improves with increasing total activity over the 300 ppmw to 600 ppmw dose range that was tested.

Samples 32 to 37 demonstrate the performance of Paraffin Wax Dispersant Composition 7, which had a total activity of 40 wt % with 5 wt % of 2-mercaptoethanol. This performance can be compared with the performance of Paraffin Wax Dispersant Composition 6, which had a total activity of 40 wt % with 2 wt % 2-mercaptoethanol. It can be seen that Paraffin Wax Dispersant Compositions 6 and 7 perform similarly at total activity of 40 wt %, for 2-mercaptoethanol concentrations of 2 wt % and 5 wt %.

### Winterization Observations

Samples were stored in a freezer at −35° C. or −40° C. The Samples were observed at Day 1, Day 2, Week 1, Week 2, Week 3, and Week 4 for clearness and haziness. A successful sample remained clear at Week 4.

It was observed that the samples having Paraffin Wax Dispersant Composition 1 survived winterization at −35° C. Thus, compositions having DDBSA in excess of MEA disperse wax paraffins in environments having temperatures as low as −35° C.

It was observed that samples having Paraffin Wax Dispersant Compositions 2 to 7 survived winterization at −40° C., suggesting that addition of 2-mercaptoethanol provided a synergistic effect for winterization, which was unexpected. 2-mercaptoethanol was originally added to samples to provide a synergistic effect with the C₁₂ to C₁₆ alkyl dimethyl benzyl ammonium chlorides for corrosion inhibition. It was unexpectedly found that addition of 2-mercaptoethanol provided enhanced performance and winterization down to −40° C. of the Paraffin Wax Dispersant Compositions having monoethanolamine in excess of dodecyl benzene sulfonic acid.

### Other Testing

Paraffin dispersant bottle tests were also conducted for samples containing paraffin wax dispersant compositions having MEA in excess of DDBSA, similar to Compositions 2 to 7, but without addition of 2-mercaptoethanol. The samples of these compositions performed unacceptably as a dispersant and are not reported herein, further suggesting that addition of 2-mercaptoethanol to paraffin wax dispersant compositions having MEA in excess of DDBSA unexpectedly enables the compositions to 1) perform as dispersant, and 2) survive winterization down to −40° C.

### Additional Description

Aspect 1. A method comprising: introducing a paraffin wax dispersant composition to a hydrocarbon fluid, wherein the paraffin wax dispersant composition comprises: a sorbitol-based compound; a quaternary ammonium compound; a solvent; monoethanolamine; and an alkyl benzene sulfonic acid.

Aspect 2. The method of Aspect 1, wherein a mass ratio of the monoethanolamine to the alkyl benzene sulfonic acid in the paraffin wax dispersant composition is less than 1:1, for example, in a range of from 0.1:1 to less than 1:1.

Aspect 3. The method of Aspect 1 or 2, wherein the paraffin wax dispersant composition contains no 2-mercaptoethanol.

Aspect 4. The method of any one of Aspects 1 to 3, having 3 wt % to 6 wt % of the sorbitol-based compound, 20 wt % to 40 wt % of the quaternary ammonium compound, 0.1 wt % to 1 wt % of the monoethanolamine, 1 wt % to 3 wt % alkyl benzene sulfonic acid, and 50 wt % to 80 wt % of the solvent, based on a total weight of the paraffin wax dispersant composition.

Aspect 5. The method of any one of Aspects 1 to 4, wherein a concentration of the paraffin wax dispersant composition in the hydrocarbon fluid is in a range of from 100 ppmw to 1,000 ppmw based on a total weight of the hydrocarbon fluid, alternatively, from 350 ppmw to 1,000 ppmw based on a total weight of the hydrocarbon fluid.

Aspect 6A. The method of any one of Aspects 1 to 5, wherein a total activity of the paraffin wax dispersant composition is in a range of from 20 wt % to 50 wt %, alternatively, from 20 wt % to 40 wt %, based on a total weight of the paraffin wax dispersant composition, wherein the total activity is defined as a sum wt % of the sorbitol-based compound, the quaternary ammonium compound, the monoethanolamine, and the alkyl benzene sulfonic acid in the paraffin wax dispersant composition.

Aspect 6B. The method of any one of Aspects 1 to 6A, wherein paraffin wax formation in the hydrocarbon fluid is prevented down to a temperature of −35° C.

Aspect 7. The method of Aspect 1, wherein a mass ratio of the monoethanolamine to the alkyl benzene sulfonic acid in the paraffin wax dispersant composition is equal to or greater than 1:1 and less than 10:1.

Aspect 8. The method of Aspect 7, wherein the paraffin wax dispersant composition further comprises 2-mercaptoethanol.

Aspect 9. The method of Aspect 8, having from 2 wt % to 5 wt % of the 2-mercaptoethanol based on a total weight of the paraffin wax dispersant composition.

Aspect 10. The method of any one of Aspects 8 to 9, wherein the paraffin wax dispersant composition has 2 wt % to 4 wt % of the sorbitol-based compound, 12 wt % to 31 wt % quaternary ammonium compound, 1.3 wt % to 2.9 wt % of the monoethanolamine, 0.2 wt % to 0.5 wt % of the alkyl benzene sulfonic acid, 2 wt % to 5 wt % of the 2-mercaptoethanol, and 56 wt % to 78 wt % of the solvent, based on a total weight of the paraffin wax dispersant composition.

Aspect 11. The method of any one of Aspects 7 to 10, wherein a concentration of the paraffin wax dispersant composition in the hydrocarbon fluid is in a range of from 100 ppmw to 1,000 ppmw based on a total weight of the hydrocarbon fluid.

Aspect 12A. The method of any one of Aspects 8 to 11, wherein a total activity of the paraffin wax dispersant composition is in a range of from 20 wt % to 50 wt %, alternatively, from 20 wt % to 40 wt %, based on a total weight of the paraffin wax dispersant composition, wherein the total activity is defined as a sum wt % of the sorbitol-based compound, the quaternary ammonium compound, the monoethanolamine, the alkyl benzene sulfonic acid, and the 2-mercaptoethanol in the paraffin wax dispersant composition.

Aspect 12B. The method of any one of Aspects 1 to 12A, wherein paraffin wax formation in the hydrocarbon fluid is prevented down to a temperature of −40° C.

Aspect 13. The method of any one of Aspects 1 to 12B, wherein the hydrocarbon fluid comprises a crude oil, a hydrocarbon gas, a condensate, or combinations thereof.

Aspect 14. A paraffin wax dispersant composition comprising: a sorbitol-based compound; a quaternary ammonium compound; a solvent; monoethanolamine; and an alkyl benzene sulfonic acid.

Aspect 15. The paraffin wax dispersant composition of Aspect 14, wherein a mass ratio of the monoethanolamine to the alkyl benzene sulfonic acid in the paraffin wax dispersant composition is less than 1:1, for example, in a range of from 0.1:1 to less than 1:1, wherein the paraffin wax dispersant composition contains no 2-mercaptoethanol.

Aspect 16. The paraffin wax dispersant composition of Aspect 14 or 15, containing 3 wt % to 6 wt % of the sorbitol-based compound, 20 wt % to 40 wt % of the quaternary ammonium compound, 0.1 wt % to 1 wt % of the monoethanolamine, 1 wt % to 3 wt % of the alkyl benzene sulfonic acid, and 50 wt % to 80 wt % of the solvent, based on a total weight of the paraffin wax dispersant composition.

Aspect 17. The paraffin wax dispersant composition of any one of Aspects 14 to 16, having a total activity of 50 wt %, alternatively, from 20 wt % to 40 wt %, based on a total weight of the paraffin wax dispersant composition, wherein the total activity is defined as a sum wt % of the sorbitol-based compound, the quaternary ammonium compound, the monoethanolamine, and the alkyl benzene sulfonic acid.

Aspect 18. The paraffin wax dispersant composition of Aspect 14, further comprising 2-mercaptoethanol.

Aspect 19. The paraffin wax dispersant composition of Aspect 18, having from 2 wt % to 5 wt % of the 2-mercaptoethanol based on a total weight of the paraffin wax dispersant composition.

Aspect 20. The paraffin wax dispersant composition of any one of Aspects 14 and 18 to 19, wherein a mass ratio of the monoethanolamine to the alkyl benzene sulfonic acid in the paraffin wax dispersant composition is equal to or greater than 1:1.

Aspect 21. The paraffin wax dispersant composition of any one of Aspects 18 to 20, containing 2 wt % to 4 wt % of the sorbitol-based compound, 12 wt % to 31 wt % quaternary ammonium compound, 1.3 wt % to 2.9 wt % of the monoethanolamine, 0.2 wt % to 0.5 wt % of the alkyl benzene sulfonic acid, 2 wt % to 5 wt % of the 2-mercaptoethanol, and 56 wt % to 78 wt % of the solvent, based on a total weight of the paraffin wax dispersant composition.

Aspect 22. The paraffin wax dispersant composition of any one of Aspects 18 to 21, having a total activity in a range of from 20 wt % to 50 wt %, alternatively, from 20 wt % to 40 wt %, based on a total weight of the paraffin wax dispersant composition, wherein the total activity is defined as a sum wt % of the sorbitol-based compound, the quaternary ammonium compound, the monoethanolamine, the alkyl benzene sulfonic acid, and the 2-mercaptoethanol.

Aspect 23. A mixture comprising: a hydrocarbon fluid; and a paraffin wax dispersant composition comprising: a sorbitol-based compound; a quaternary ammonium compound; a solvent; monoethanolamine; and an alkyl benzene sulfonic acid.

Aspect 24. The mixture of Aspect 23, wherein the hydrocarbon fluid comprises a crude oil, a hydrocarbon gas, a condensate, or combinations thereof.

Aspect 25. The mixture of Aspect 23 or 24, wherein a mass ratio of the monoethanolamine to the alkyl benzene sulfonic acid in the paraffin wax dispersant composition is less than 1:1, for example, in a range of from 0.1:1 to less than 1:1, wherein the paraffin wax dispersant composition contains no 2-mercaptoethanol.

Aspect 26. The mixture of any one of Aspects 23 to 25, wherein the paraffin wax dispersant composition has 3 wt % to 6 wt % of the sorbitol-based compound, 20 wt % to 40 wt % of the quaternary ammonium compound, 0.1 wt % to 1 wt % of the monoethanolamine, 1 wt % to 3 wt % of the alkyl benzene sulfonic acid, and 50 wt % to 80 wt % of the solvent, based on a total weight of the paraffin wax dispersant composition.

Aspect 27. The mixture of any one of Aspects 23 to 26, having a total activity in a range of 20 wt % to 50 wt %, alternatively, from 20 wt % to 40 wt %, based on a total weight of the paraffin wax dispersant composition, wherein the total activity is defined as a sum wt % of the sorbitol-based compound, the quaternary ammonium compound, the monoethanolamine, and the alkyl benzene sulfonic acid in the paraffin wax dispersant composition.

Aspect 28A. The mixture of any one of Aspects 23 to 27, wherein a concentration of the paraffin wax dispersant composition in the hydrocarbon fluid is in a range of from 100 ppmw to 1,000 ppmw based on a total weight of the hydrocarbon fluid, alternatively, from 350 ppmw to 1,000 ppmw based on a total weight of the hydrocarbon fluid.

Aspect 28B. The mixture of any one of Aspects 23 to 28A, wherein the paraffin wax dispersant composition prevents paraffin wax formation in the hydrocarbon fluid down to a temperature of −35° C.

Aspect 29. The mixture of Aspect 23, further comprising 2-mercaptoethanol.

Aspect 30. The mixture of Aspect 29, having from 2 wt % to 5 wt % of the 2-mercaptoethanol based on a total weight of the paraffin wax dispersant composition.

Aspect 31. The mixture of any one of Aspects 23 and 29 to 30, wherein a mass ratio of the monoethanolamine to the alkyl benzene sulfonic acid in the paraffin wax dispersant composition is equal to or greater than 1:1.

Aspect 32. The mixture of any one of Aspects 29 to 31, wherein the paraffin wax dispersant composition has 2 wt % to 4 wt % of the sorbitol-based compound, 12 wt % to 31 wt % quaternary ammonium compound, 1.3 wt % to 2.9 wt % of the monoethanolamine, 0.2 wt % to 0.5 wt % of the alkyl benzene sulfonic acid, 2 wt % to 5 wt % of the 2-mercaptoethanol, and 56 wt % to 78 wt % of the solvent, based on a total weight of the paraffin wax dispersant composition.

Aspect 33. The mixture of any one of Aspects 29 to 32, having a total activity in a range of from 20 wt % to 50 wt %, alternatively, from 20 wt % to 40 wt %, based on a total weight of the paraffin wax dispersant composition, wherein the total activity is defined as a sum wt % of the sorbitol-based compound, the quaternary ammonium compound, the monoethanolamine, the alkyl benzene sulfonic acid, and the 2-mercaptoethanol in the paraffin wax dispersant composition.

Aspect 34A. The mixture of any one of Aspects 23 and 29 to 33, wherein a concentration of the paraffin wax dispersant composition in the hydrocarbon fluid is in a range of from 100 ppmw to 1,000 ppmw based on a total weight of the hydrocarbon fluid.

Aspect 34B. The mixture of any one of Aspects 23 and 29 to 34A, wherein the paraffin wax dispersant composition prevents paraffin wax formation in the hydrocarbon fluid down to a temperature of −40° C.

Aspect 35. A method comprising: storing or transporting a hydrocarbon fluid in or through a vessel, wherein the hydrocarbon fluid contains a paraffin wax dispersant composition comprising: a sorbitol-based compound; a quaternary ammonium compound; a solvent; monoethanolamine; and an alkyl benzene sulfonic acid.

Aspect 36. The method of Aspect 35, wherein a mass ratio of the monoethanolamine to the alkyl benzene sulfonic acid in the paraffin wax dispersant composition is less than 1:1, for example, in a range of from 0.1:1 to less than 1:1.

Aspect 37. The method of Aspect 35 or 36, wherein the paraffin wax dispersant composition contains no 2-mercaptoethanol.

Aspect 38. The method of any one of Aspects 35 to 37, having 3 wt % to 6 wt % of the sorbitol-based compound, 20 wt % to 40 wt % of the quaternary ammonium compound, 0.1 wt % to 1 wt % of the monoethanolamine, 1 wt % to 3 wt % alkyl benzene sulfonic acid, and 50 wt % to 80 wt % of the solvent, based on a total weight of the paraffin wax dispersant composition.

Aspect 39. The method of any one of Aspects 35 to 38, wherein a concentration of the paraffin wax dispersant composition in the hydrocarbon fluid is in a range of from 100 ppmw to 1,000 ppmw based on a total weight of the hydrocarbon fluid, alternatively, from 350 ppmw to 1,000 ppmw based on a total weight of the hydrocarbon fluid.

Aspect 40A. The method of any one of Aspects 35 to 39, wherein a total activity of the paraffin wax dispersant composition is in a range of from 20 wt % to 50 wt %, alternatively, from 20 wt % to 40 wt %, based on a total weight of the paraffin wax dispersant composition, wherein the total activity is defined as a sum wt % of the sorbitol-based compound, the quaternary ammonium compound, the monoethanolamine, and the alkyl benzene sulfonic acid in the paraffin wax dispersant composition.

Aspect 40B. The method of any one of Aspects 35 to 40A, wherein the paraffin wax dispersant composition prevents paraffin wax formation in the hydrocarbon fluid down to a temperature of −35° C.

Aspect 41. The method of Aspect 35, wherein a mass ratio of the monoethanolamine to the alkyl benzene sulfonic acid in the paraffin wax dispersant composition is equal to or greater than 1:1 and less than 10:1.

Aspect 42. The method of Aspect 41, wherein the paraffin wax dispersant composition further comprises 2-mercaptoethanol.

Aspect 43. The method of Aspect 42, having from 2 wt % to 5 wt % of the 2-mercaptoethanol based on a total weight of the paraffin wax dispersant composition.

Aspect 44. The method of any one of Aspects 42 to 43, wherein the paraffin wax dispersant composition has 2 wt % to 4 wt % of the sorbitol-based compound, 12 wt % to 31 wt % quaternary ammonium compound, 1.3 wt % to 2.9 wt % of the monoethanolamine, 0.2 wt % to 0.5 wt % of the alkyl benzene sulfonic acid, 2 wt % to 5 wt % of the 2-mercaptoethanol, and 56 wt % to 78 wt % of the solvent, based on a total weight of the paraffin wax dispersant composition.

Aspect 45. The method of any one of Aspects 41 to 44, wherein a concentration of the paraffin wax dispersant composition in the hydrocarbon fluid is in a range of from 100 ppmw to 1,000 ppmw based on a total weight of the hydrocarbon fluid.

Aspect 46A. The method of any one of Aspects 42 to 45 wherein a total activity of the paraffin wax dispersant composition is in a range of from 20 wt % to 50 wt %, alternatively, from 20 wt % to 40 wt %, based on a total weight of the paraffin wax dispersant composition, wherein the total activity is defined as a sum wt % of the sorbitol-based compound, the quaternary ammonium compound, the monoethanolamine, the alkyl benzene sulfonic acid, and the 2-mercaptoethanol in the paraffin wax dispersant composition.

Aspect 46B. The method of any one of Aspects 42 to 46A, wherein the paraffin wax dispersant composition prevents paraffin wax formation in the hydrocarbon fluid down to a temperature of −40° C.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method comprising:
introducing a paraffin wax dispersant composition to a hydrocarbon fluid, wherein the paraffin wax dispersant composition comprises:
a sorbitol-based compound;
a quaternary ammonium compound;
a solvent;
monoethanolamine; and
an alkyl benzene sulfonic acid.

2. The method of claim 1, wherein a mass ratio of the monoethanolamine to the alkyl benzene sulfonic acid in the paraffin wax dispersant composition is less than 1:1.

3. The method of claim 2, wherein the paraffin wax dispersant composition contains no 2-mercaptoethanol.

4. The method of claim 2, wherein a concentration of the paraffin wax dispersant composition in the hydrocarbon fluid is in a range of from 350 ppmw to 1,000 ppmw based on a total weight of the hydrocarbon fluid.

5. The method of claim 1, wherein a total activity of the paraffin wax dispersant composition is in a range of from 20 wt % to 50 wt % based on a total weight of the paraffin wax dispersant composition, wherein the total activity is defined as a sum wt % of the sorbitol-based compound, the quaternary ammonium compound, the monoethanolamine, and the alkyl benzene sulfonic acid in the paraffin wax dispersant composition.

6. The method of claim 1, wherein a mass ratio of the monoethanolamine to the alkyl benzene sulfonic acid in the paraffin wax dispersant composition is equal to or greater than 1:1 and less than 10:1.

7. The method of claim 6, wherein the paraffin wax dispersant composition further comprises 2-mercaptoethanol.

8. The method of claim 7, having from 2 wt % to 5 wt % of the 2-mercaptoethanol based on a total weight of the paraffin wax dispersant composition.

9. The method of claim 7, wherein a concentration of the paraffin wax dispersant composition in the hydrocarbon fluid is in a range of from 100 ppmw to 1,000 ppmw based on a total weight of the hydrocarbon fluid.

10. The method of claim 7, wherein a total activity of the paraffin wax dispersant composition is in a range of from 20 wt % to 50 wt % based on a total weight of the paraffin wax dispersant composition, wherein the total activity is defined as a sum wt % of the sorbitol-based compound, the quaternary ammonium compound, the monoethanolamine, the alkyl benzene sulfonic acid, and the 2-mercaptoethanol in the paraffin wax dispersant composition.

11. The method of claim 1, wherein the hydrocarbon fluid comprises a crude oil, a hydrocarbon gas, a condensate, or combinations thereof.

12. A paraffin wax dispersant composition comprising:
a sorbitol-based compound;
a quaternary ammonium compound;
a solvent;
monoethanolamine; and
an alkyl benzene sulfonic acid.

13. The paraffin wax dispersant composition of claim 12, wherein a mass ratio of the monoethanolamine to the alkyl benzene sulfonic acid in the paraffin wax dispersant composition is less than 1:1, wherein the paraffin wax dispersant composition contains no 2-mercaptoethanol.

14. The paraffin wax dispersant composition of claim 13, containing 3 wt % to 6 wt % of the sorbitol-based compound, 20 wt % to 40 wt % of the quaternary ammonium compound, 0.1 wt % to 1 wt % of the monoethanolamine, 1 wt % to 3 wt % of the alkyl benzene sulfonic acid, and 50 wt % to 80 wt % of the solvent, based on a total weight of the paraffin wax dispersant composition.

15. The paraffin wax dispersant composition of claim 13, having a total activity of 50 wt % based on a total weight of the paraffin wax dispersant composition, wherein the total activity is defined as a sum wt % of the sorbitol-based compound, the quaternary ammonium compound, the monoethanolamine, and the alkyl benzene sulfonic acid.

16. The paraffin wax dispersant composition of claim 12, further comprising 2-mercaptoethanol, wherein a mass ratio of the monoethanolamine to the alkyl benzene sulfonic acid in the paraffin wax dispersant composition is equal to or greater than 1:1.

17. The paraffin wax dispersant composition of claim 16, having from 2 wt % to 5 wt % of the 2-mercaptoethanol based on a total weight of the paraffin wax dispersant composition.

18. The paraffin wax dispersant composition of claim 16, containing 2 wt % to 4 wt % of the sorbitol-based compound, 12 wt % to 31 wt % quaternary ammonium compound, 1.3 wt % to 2.9 wt % of the monoethanolamine, 0.2 wt % to 0.5 wt % of the alkyl benzene sulfonic acid, 2 wt % to 5 wt % of the 2-mercaptoethanol, and 56 wt % to 78 wt % of the solvent, based on a total weight of the paraffin wax dispersant composition.

19. The paraffin wax dispersant composition of claim 16, having a total activity in a range of from 20 wt % to 50 wt % based on a total weight of the paraffin wax dispersant composition, wherein the total activity is defined as a sum wt % of the sorbitol-based compound, the quaternary ammonium compound, the monoethanolamine, the alkyl benzene sulfonic acid, and the 2-mercaptoethanol.

20. A mixture comprising:
a hydrocarbon fluid; and
the paraffin wax dispersant composition of claim 12.
